(19) United States
(12) Patent Application Publication
(10) Pub. No.: US 2006/0104204 A1
(43) Pub. Date: May 18, 2006

(54) Power efficient mobile terminal reception mode

(76) Inventors: Johan Hansson, Malmo (SE); Goran Pehrsson, Malmo (SE); Emma Wittenmark, Lund (SE); Bjorn Rikte, Malmo (SE)

Correspondence Address: POTOMAC PATENT GROUP, PLLC, P. O. BOX 270, FREDERICKSBURG, VA, 22404, US

(21) Appl. No.: 10/987,766

(22) Filed: Nov. 12, 2004

(51) Int. Cl. H04L 12/26; H04B 7/212

(52) U.S. Cl. 370/235; 714/748; 370/252; 370/338

(57) ABSTRACT

A message that comprises encoded bits interleaved over N transmission bursts, wherein N is greater than 1, is received by receiving fewer than N of the transmission bursts, whereby there exist remaining ones of the N transmission bursts that have not been received. All of the received transmission bursts are decoded to generate decoded data. It is then determined whether the decoded data is error free. Reception of remaining transmission bursts of the message is inhibited if the decoded data is error free, otherwise one or more remaining ones of the N transmission bursts are received.

### BACKGROUND

The present invention relates to mobile communications systems, more particularly to mobile terminals in mobile communications systems, and still more particularly to a standby mode of operation of a mobile terminal.

A mobile communications system includes one or more mobile terminals that communicate wirelessly with a supporting network. The network is responsible for such things as routing calls between mobile terminals within the network, and between any of the mobile terminals and other communication devices outside of the network such as landline telephones that are connected by wire to a Public Switched Telephone Network (PSTN). (As used herein, the term “call” is used not only to refer to communication of voice information between users, but more broadly to include any type of communication (receiving and/or transmitting) that the mobile terminal may be capable of, such as communicating data that may be representative of things other than voice. Such things include, but are not limited to text, images, sounds, and position information.)

A network typically comprises a number of geographically distributed base stations. The area served by a base station is called a cell. The mobile terminal communicates wirelessly with one of these base stations, and it is this link that connects the mobile terminal with the network as a whole. As the mobile terminal moves around, a decision is made regarding which of the base stations is presently best able to provide service to the mobile terminal, and it is this base station with which the mobile terminal is instructed to communicate. As conditions change (e.g., as the mobile terminal moves away from its base station), the mobile terminal may be instructed to instead communicate with a different base station more suitable for present conditions.

When a mobile terminal for use in a mobile communications system is switched on but not actively engaged in communicating user data, it typically operates in an idle mode. During idle mode, the mobile terminal performs tasks that enable it to be ready for use, either to initiate or receive a call. While the particular list of tasks to be performed in idle mode and the way these tasks are performed may vary from one system to the next, some functions are common to a number of systems. To facilitate this discussion, reference will be made to aspects of the standardized Global System for Mobile communication (GSM). However, it should be recognized that the various aspects of the invention described herein are not limited to application only in GSM, but are instead applicable to any system having similar characteristics as described herein.

The tasks that the mobile terminal must perform while in idle mode are often specified by the standards within which the mobile terminal is to operate. These mandatory tasks are rather power consuming because they involve the radio receiver.

For example, one of the tasks in idle mode (as specified in the GSM standards) is to listen to the paging channel (PCH). The network uses the paging channel to tell the mobile terminal whether there is an incoming call, a Short Message Service (SMS) message, or any other inbound communication. The periodic utilization of the PCH is set by the network.

Another task to be performed in idle mode is to listen to the broadcast channel (BCCH), both on the serving cell and on neighboring cells. The occurrence of the BCCH is set by the network but is also dependent on traffic conditions (e.g., the number of neighboring cells, which will change as the mobile terminal moves around).

It is mandatory to receive and decode all messages sent on the PCH and BCCH, so not performing these functions is not an option.

Mobile terminals are conventionally powered by a battery. The longer the battery stays charged, the longer the user is able to utilize the mobile terminal without having to connect it to a recharger or otherwise replace the battery. It would be especially frustrating for a user to find that after only a short period of time, he or she is unable to use the mobile terminal because it has become discharged merely from being in the idle mode. Consequently, when the mobile terminal is in idle mode, it is important to reduce the power consumption as much as possible. How often the radio receiver is used has a big impact on the amount of power consumption. It is therefore desirable to provide a way of performing the required idle mode tasks in a way that uses less power than conventional techniques.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods and apparatuses that receive a message that comprises encoded bits interleaved over N transmission bursts, wherein N is greater than 1. This includes receiving fewer than N of the transmission bursts, whereby there exist remaining ones of the N transmission bursts that have not been received. All of the received transmission bursts are decoded to generate decoded data. It is then determined whether the decoded data is error free. Reception of remaining transmission bursts of the message is inhibited if the decoded data is error free; otherwise one or more remaining ones of the N transmission bursts are received.

In another aspect, receiving one or more remaining ones of the N transmission bursts includes:

a) receiving one of the remaining ones of the N transmission bursts;

b) producing a combination of transmission bursts by combining the received one of the remaining ones of the N transmission bursts with all previously received ones of the N transmission bursts;

c) decoding the combination of transmission bursts to generate new decoded data;

d) determining whether the new decoded data is error free; and

e) inhibiting reception of remaining transmission bursts of the message if the new decoded data is error free, otherwise repeating a) through e) until all N transmission bursts have been received.

The various aspects of the invention may be applied by a mobile terminal while in idle mode.

In some embodiments, the message is a Broadcast Control Channel message, a Paging Channel Message, or both.

By receiving fewer than all of the N blocks, power savings may be achieved.

### BRIEF DESCRIPTION OF THE DRAWINGS

The objects and advantages of the invention will be understood by reading the following detailed description in conjunction with the drawings in which:

FIG. 1 depicts the informational content and layout of a GSM paging message.

FIG. 2 is a block diagram illustrating how a paging message is processed prior to transmission.

FIG. 3 is a flowchart depicting the conventional way of receiving messages on the logical channels in GSM.

FIG. 4 is a flowchart of an exemplary embodiment in accordance with the invention.

FIGS. 5a, 5b, and 5c are graphs showing, respectively, exemplary power consumption when only 2 PCH bursts are received (FIG. 5a), when 3 PCH bursts are received (FIG. 5b), and when 4 PCH bursts are received (FIG. 5c).

FIG. 6a is a set of graphs depicting bit error rate (BLER) plotted as a function of the signal-to-noise ratio (Eb/NO) for a static channel.

FIG. 6b is a set of graphs depicting block error rate (BER) plotted as a function of the signal-to-noise ratio (Eb/NO) for a static channel.

FIG. 7a is a set of graphs depicting bit error rate (BER) plotted as a function of the signal-to-noise ratio (Eb/NO) for a TU50 channel without frequency hopping.

FIG. 7b is a set of graphs depicting block error rate (BLER) plotted as a function of the signal-to-noise ratio (Eb/NO) for a TU50 channel without frequency hopping.

FIG. 8a is a set of graphs depicting bit error rate (BER) plotted as a function of the signal-to-noise ratio (C/I) for a TU3 channel without frequency hopping.

FIG. 8b is a set of graphs depicting block error rate (BLER) plotted as a function of the signal-to-noise ratio (C/I) for a TU3 channel without frequency hopping.

FIG. 9a is a set of graphs depicting bit error rate (BER) plotted as a function of the signal-to-noise ratio (C/I) for a TU50 channel without frequency hopping.

FIG. 9b is a set of graphs depicting block error rate (BLER) plotted as a function of the signal-to-noise ratio (C/I) for a TU50 channel without frequency hopping.

FIG. 10a is a set of graphs depicting bit error rate (BER) plotted as a function of the signal-to-noise ratio (C/I) for a TU50 channel with ideal frequency hopping.

FIG. 10b is a set of graphs depicting block error rate (BLER) plotted as a function of the signal-to-noise ratio (C/I) for a TU50 channel with ideal frequency hopping.

FIG. 11a is a set of graphs depicting bit error rate (BER) plotted as a function of the signal-to-noise ratio (C/I) for a TU3 channel with ideal frequency hopping.

FIG. 11b is a set of graphs depicting block error rate (BLER) plotted as a function of the signal-to-noise ratio (C/I) for a TU3 channel with ideal frequency hopping.

FIG. 12a is a set of graphs depicting bit error rate (BER) plotted as a function of the signal-to-noise ratio (Eb/NO) for a TU50 channel with ideal frequency hopping.

FIG. 12b is a set of graphs depicting block error rate (BLER) plotted as a function of the signal-to-noise ratio (Eb/NO) for a TU50 channel with ideal frequency hopping.

FIG. 13 is a set of graphs depicting the average number of bursts needed for a fire decoder to declare an error free block plotted as a function of the signal-to-noise ratio (Eb/NO).

FIG. 14 is a set of graphs depicting the average number of bursts needed for a fire decoder to declare an error free block plotted as a function of the carrier-to-interference (C/I).

FIG. 15 is a set of graphs depicting the average number of bursts needed for a fire decoder to declare an error free block plotted as a function of the carrier-to-interference ratio (C/I).

FIG. 16 is a set of graphs depicting the average number of bursts needed for a fire decoder to declare an error free block plotted as a function of the signal-to-noise ratio (Eb/NO).

FIG. 17 is a set of graphs depicting the probability of x bursts being required to decode an error free message as a function of signal-to-noise ratio (Eb/NO) on a static channel.

FIG. 18 is a set of graphs depicting the probability of x bursts being required to decode an error free message as a function of signal-to-noise ratio (Eb/NO) on a TU50 channel without frequency hopping.

FIG. 19 is a set of graphs depicting the probability of x bursts being required to decode an error free message as a function of carrier-to-interference ratio (C/I) on a TU3 channel without frequency hopping.

FIG. 20 is a set of graphs depicting the probability of x bursts being required to decode an error free message as a function of carrier-to-interference ratio (C/I) on a TU50 channel without frequency hopping.

FIG. 21 is a set of graphs depicting the probability of x bursts being required to decode an error free message as a function of carrier-to-interference ratio (C/I) on a TU50 channel with ideal frequency hopping.

FIG. 22 is a set of graphs depicting the probability of x bursts being required to decode an error free message as a function of carriers-to-interference ratio (C/I) on a TU3 channel with ideal frequency hopping.

FIG. 23 is a set of graphs depicting the probability of x bursts being required to decode an error free message as a function of signal-to-noise ratio (Eb/NO) on a TU50 channel with ideal frequency hopping.

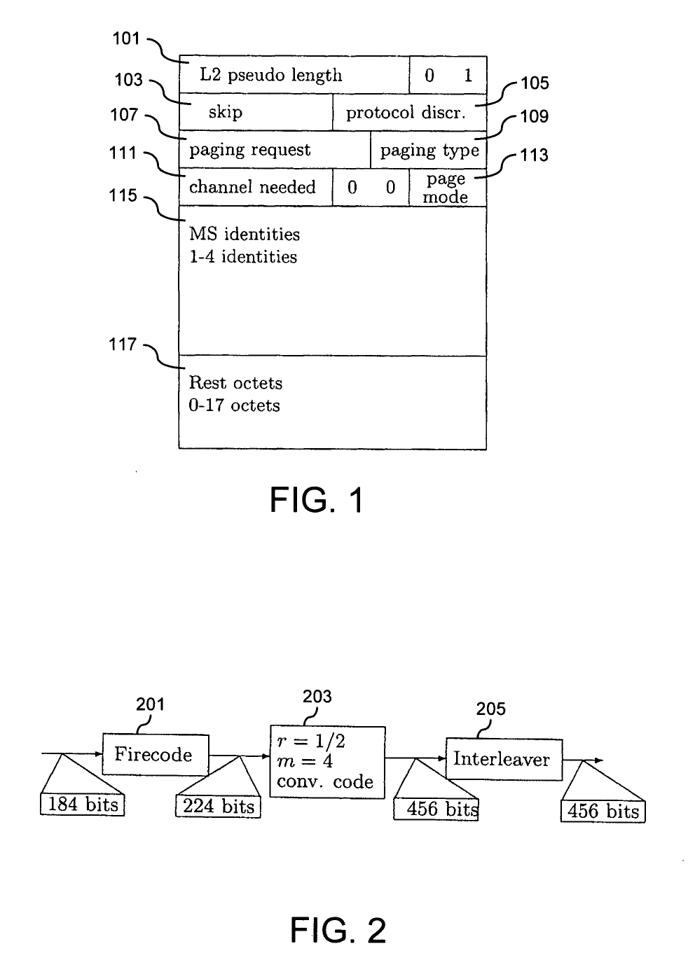

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

As mentioned earlier, it is desirable to provide a way of performing the required idle mode tasks in a way that uses less power than conventional techniques. In order to facilitate an understanding of the various aspects of the invention, relevant characteristics of a GSM system will first be described. While the exemplary embodiments are described with reference to GSM systems, it should be understood that the invention may be practiced in other systems as well, such as in GSM Packet Radio Service (GPRS) systems (e.g., for the GPRS packet Paging CHannel (PPCH) and the Packet Broadcast Control CHannel (PBCCH)). Furthermore, the invention may be applied not only in mobile transceivers, but also for receiving bursts at the Base Station/Network side of a mobile communications network. Additionally, the invention is not limited to use only in idle mode; it may be used in other operating modes as well.

In a GSM system, paging messages are transmitted on the Paging Channel (PCH), which is a control channel. The message consists of 184 information bits which are encoded into 456 bits. The encoded message is split into four bursts which are sent in different TDMA frames.

There are three types of paging messages: Type 1, 2, and 3 respectively. They differ in the number of mobiles they can page and in the type of addressing used (International Mobile Subscriber Identity (IMSI) or Temporary Mobile Subscriber Identity (TMSI)).

FIG. I depicts the informational content and layout of a GSM paging message 100. An L2 pseudo length field 101 specifies the length of the paging message 100, not including the rest octets 117 and the length of the L2 pseudo length field 101 itself.

A skip indicator 103 is a four bit field. The four bits should be set to 0000 for the paging message 100 to be considered valid; otherwise, the paging message 100 should be ignored.

A protocol discriminator field 105 designates the type of message being represented. For paging use, the protocol discriminator field 105 should convey a radio resource management message of 0110.

To indicate the message type, a five bit field 107 (bits 8-4) is set to indicate a paging request (00100) and a three bit field 109 (bits 3-1) is set to indicate one of three different types of paging types: 001 for paging request type 1, 010 for paging request type 2, and 100 for paging request type 3.

A channel needed field 111 is a four bit field capable of indicating a type of channel for either one or two mobile terminals. The channel needed field 111 itself comprises two 2-bit fields: one for each of the two possible mobile terminals. Each of these 2-bit fields is encoded as follows: 00 for any channel, 01 for SDCCH, 10 for TCH/F, and 11 for TCH/H or TCH/F. If only one mobile is being addressed by the paging message 100, then only bits 6-5 are used and bits 8-7 are spare.

A page mode field 113 is encoded as 00 for normal paging, 01 for extended paging, 10 for paging reorganization, and 11 for same as before.

The three paging type messages can page a different number of mobile stations at the same time. A message of type 1 can page 1 or 2 mobile stations, a message of type 2 can page 2-3 mobile stations, and a message of type 3 can page 3-4 mobile stations. The address formats are different between the different messages types. Either the IMSI of TMSI/P-TMSI can be used depending on which type of paging message that is being used. For more information, the interested reader can refer to GSM 04.08: “Digital cellular telecommunications system (Phase 2+): Mobile radio interface layer 3 specification”, version 7.8.0, Release 1998.

FIG. 2 is a block diagram illustrating how a paging message 100 is processed prior to transmission. The paging message 100, consisting of 184 information bits, is first processed by a shortened fire coder 201, which adds 40 parity bits using the following generator polynomial:
g(D)=D⁴⁰+D²⁶+D²³+D¹⁷+D³+1.

The resulting 224 bits are then encoded by a rate r=½ convolutional encoder 203. The convolutional encoder 203 is a memory m=4 code with the following generator matrix:
G(D)=(1+D³+D⁴ 1+D+D³+D⁴)

The resulting encoded message, consisting of 456 bits, are supplied to an interleaver 205, which block interleaves the 456 bits over four bursts according to the following rule:

i(B,j)=c(n,k) for k=0,1, . . . ,455 where
n=0,1, . . . ,
   B=B₀+4n+(k mod 4)
   j=2((49k mod 57)+(k mod 8)div 4)

The resulting four bursts with encoded and interleaved data are sent on timeslot 0 on carrier frequency C₀. For more information about this aspect of the GSM system, the interested reader may refer to GSM 05.03: “Digital cellular telecommunications system (Phase 2+): Channel coding”, version 8.3.0, Release 1999. The paging channel used in systems operating in accordance with the General Packet Radio Service (GPRS) are similar, but are allowed to be frequency hopping.

Information on the BCCH is formatted in a similar way as just described. The coding scheme is also the same.

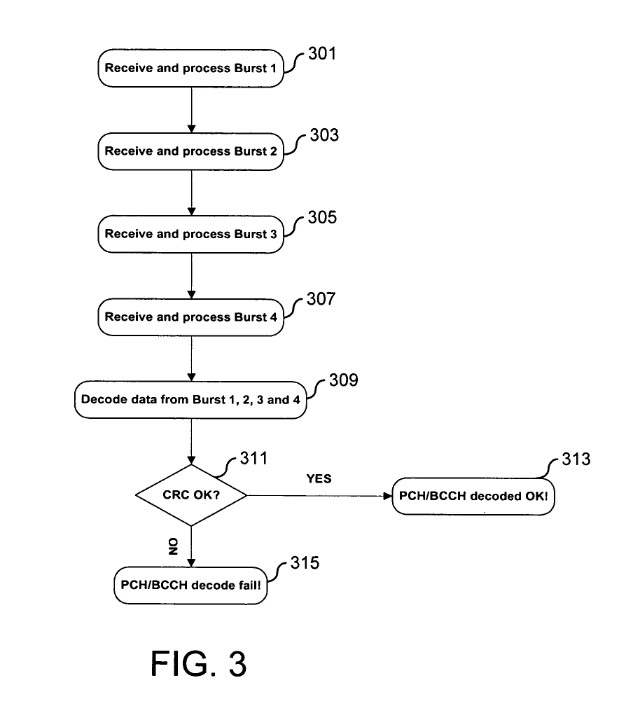

The messages on the logical channels in GSM (e.g., PCH and BCCH) are interleaved (spread) over several (usually four) bursts on the radio/physical channel. FIG. 3 is a flowchart depicting the conventional way of receiving these messages.

First, Burst 1 is received and processed (e.g., by equalizing and deinterleaving the received burst) (block 301), followed by reception and processing of Burst 2 (block 303), Burst 3 (block 305) and Burst 4 (block 307). After all four bursts have been received and processed, the data from Bursts 1, 2, 3, and 4 are decoded (block 309). If a comparison between a newly calculated cyclic redundancy code (CRC) and a CRC included within the decoded data shows that the decoded data is correct (“YES” path out of decision block 311), then the received data (i.e., for the PCH or BCCH) is used for its intended purpose by the mobile terminal (block 313). Alternatively, if the CRC shows that the decoded data contains one or more errors (“NO” path out of decision block 311), then PCH/BCCH decoding failure processing is performed (block 315).

It can be seen, then, that using conventional techniques, all bursts are first received before any processing and/or decoding of the data is started. At the conclusion of this processing, the decoder will either output the decoded bits, or the Bad Frame Indication will be set in the case of faulty CRC.

In accordance with an aspect of the invention, power savings can be achieved in idle mode by only receiving as many of the four bursts of the logical channel message (PCH or BCCH) as necessary under the given channel conditions. If the radio conditions are good, it shouldn't be necessary to receive and decode all bursts since the coded message contains redundant bits (e.g., the PCH contains 184 information bits which, after encoding, become 456 coded bits that, when transmitted, are interleaved over four bursts). When tested under simulated radio conditions, it has been shown that under good radio conditions, decoding the data from only two bursts is sufficient to recreate the original message. If the radio conditions are a little worse, it may be necessary to use the data from three bursts, but this still saves the power associated with having to operate the radio receiver to receive the fourth burst.

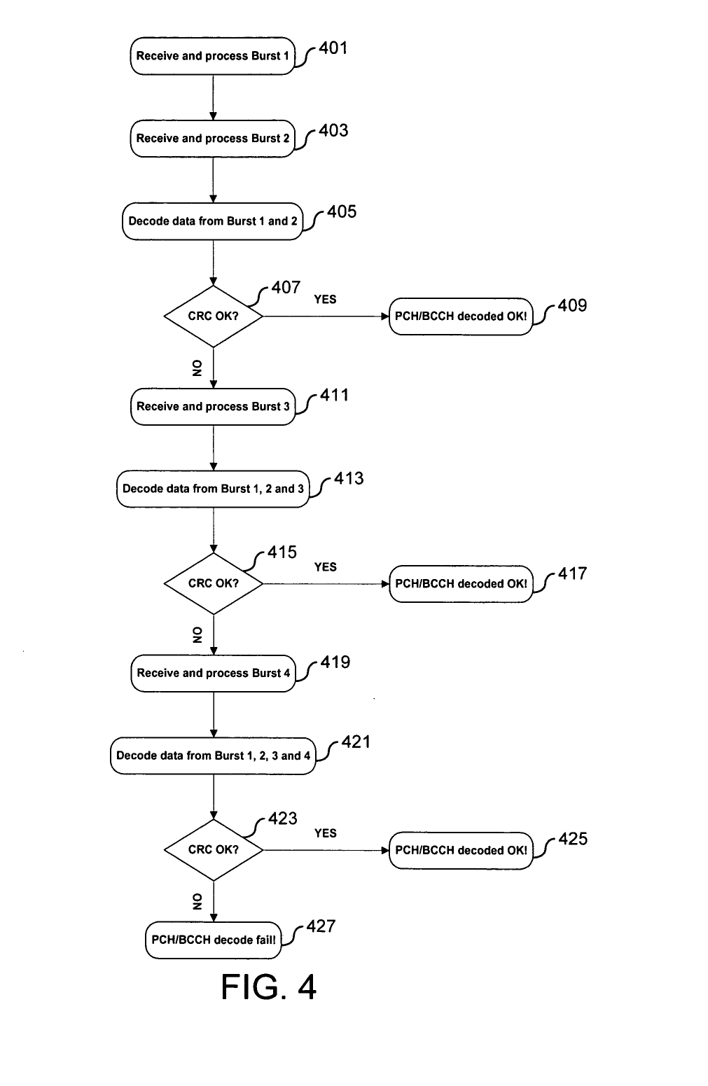

FIG. 4 is a flowchart of an exemplary embodiment. It begins by receiving and processing Burst 1 of the message (block 401). Since in this example, it is theoretically impossible to guarantee correct decoding of the message with the data from only one burst, no attempt to decode this burst is made. Instead, processing continues by receiving and processing Burst 2 (block 403). As stated earlier, two bursts may be sufficient to accurately recreate the information bits of the logical channel if they were transmitted under good channel conditions. Therefore, the processed bits from the first two bursts are decoded (block 405). This can be performed by, for example, generating all zeroes or all ones to represent the bits from the unreceived bursts, and then performing a normal deinterleaving and decoding operation on the entirety of the data.

A test is then performed (e.g., by generating a CRC from the decoded data and comparing this with the CRC included in the decoded data, the CRC having been generated for inclusion in the message by the fire coder 201) to determine whether the decoded bits are error-free (decision block 407). If they are (“YES” path out of decision block 407), then the receiver can be switched off to save power and the received data (i.e., for the PCH or BCCH) is used for its intended purpose by the mobile terminal (block 409). This can include sending the decoded message to higher layers in the protocol.

Alternatively, if the CRC shows that the decoded data contains one or more errors (“NO” path out of decision block 311), then the mobile terminal receives and processes Burst 3 (step 411). The processed bits from the first three bursts are then decoded (block 413). A test is then performed, as before, to determine whether the decoded bits are error-free (decision block 415). If they are (“YES” path out of decision block 415), then the receiver can be switched off to save power and the received data (i.e., for the PCH or BCCH) is used for its intended purpose by the mobile terminal (block 417). This can include sending the decoded message to higher layers in the protocol.

Alternatively, if the CRC shows that the decoded data contains one or more errors (“NO” path out of decision block 415), then the mobile terminal receives and processes the (in this example) final burst—Burst 4 (step 419). The processed bits from all four bursts are then decoded (block 421). If a test of these bits shows that the decoded data is correct (“YES” path out of decision block 423), then the received data (i.e., for the PCH or BCCH) is used for its intended purpose by the mobile terminal (block 425). Alternatively, if the CRC shows that the decoded data contains one or more errors (“NO” path out of decision block 423), then PCH/BCCH decoding failure processing is performed (block 427) because in this example there are no more bursts to be received with respect to this PCH/BCCH message.

The embodiment depicted in FIG. 4 assumes that the total number of transmitted bursts is four. It will be recognized that in other embodiments, the message may be spread out (interleaved) in fewer or more than four bursts. Those skilled in the art will readily be able adapt the principles illustrated in FIG. 4 accordingly by adding or deleting decode and test logic in correspondence with the number of expected bursts. More generally expressed, the idea for power saving in idle mode is to, in good channel conditions, only receive as many bursts of the multi-burst message as necessary to decode the message, and hence be able to turn off the receiver earlier than if all of the bursts were to be received. For example, if it is enough to read two out of four bursts, half of the power used for message reception can be saved. The total idle mode power saving is of course less since tasks other than receiving the multi-burst PCH/BCCH messages are performed in idle mode. The particular number of bursts that will have to be received will depend on the channel conditions.

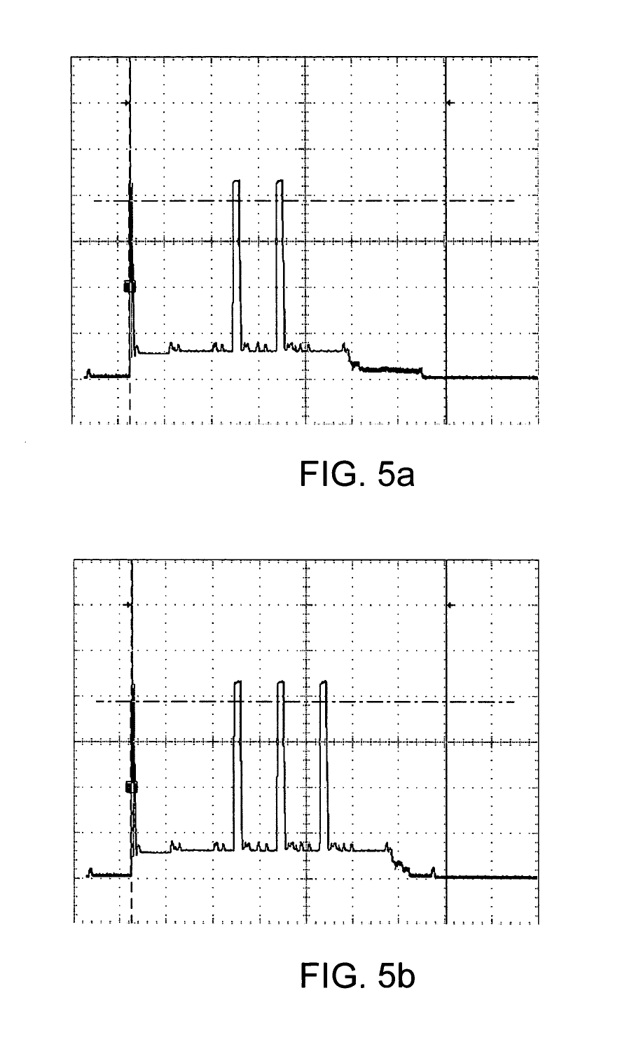

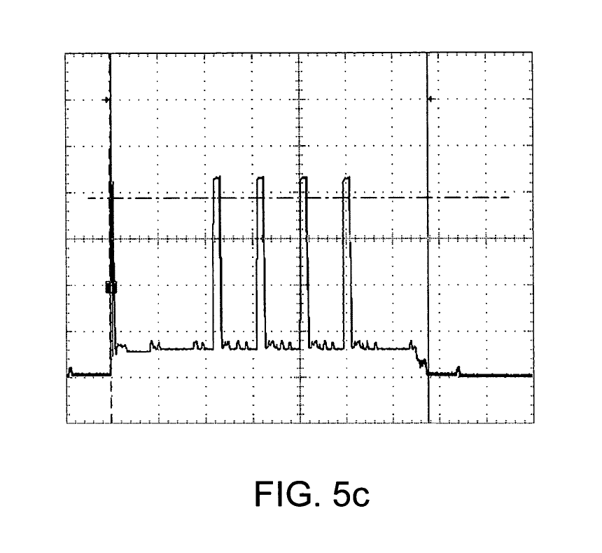

To illustrate the power savings that are possible, FIGS. 5a, 5b, and 5c are graphs showing, respectively, exemplary power consumption when only 2 PCH bursts are received (FIG. 5a), when 3 PCH bursts are received (FIG. 5b), and when 4 PCH bursts are received (FIG. 5c). It can be seen that the power consumed is directly proportional to the number of bursts that are received.

To help quantify the performance gains that are obtainable by applying the inventive principles described above, a number of received signals propagating through different channel conditions were simulated. Based on these simulated signals, the average number of bursts needed to get an error-free message under different channel conditions was measured. Also measured was the probability of x bursts being required for an error free message under different channel conditions. Furthermore, bit error rate and block error rate were measured for the paging channel. Measurements were made for a static channel, a TU50 sensitivity channel, a TU3 channel with co-channel interference, and a TU50 channel with co-channel interference. (TU3 AND TU50 channels are well-known in the art, and need not be described here in detail.) Measurements conditions included both frequency hopping and non-frequency hopping channels. (This information is useful because the GSM paging channel is always sent on carrier frequency C₀, whereas the GPRS paging is allowed to be frequency hopping.)

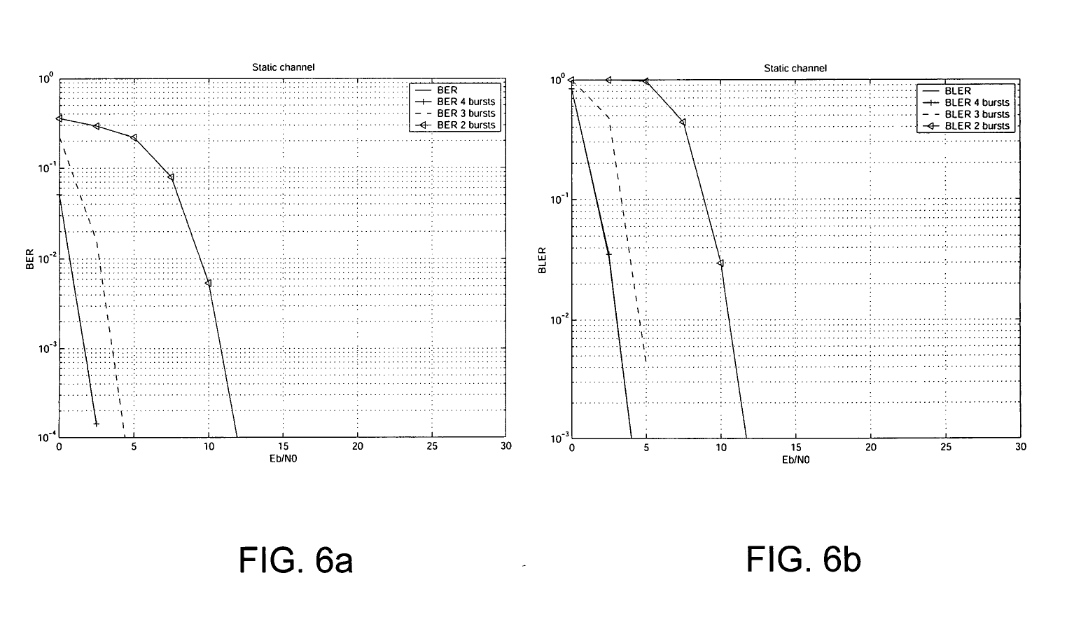

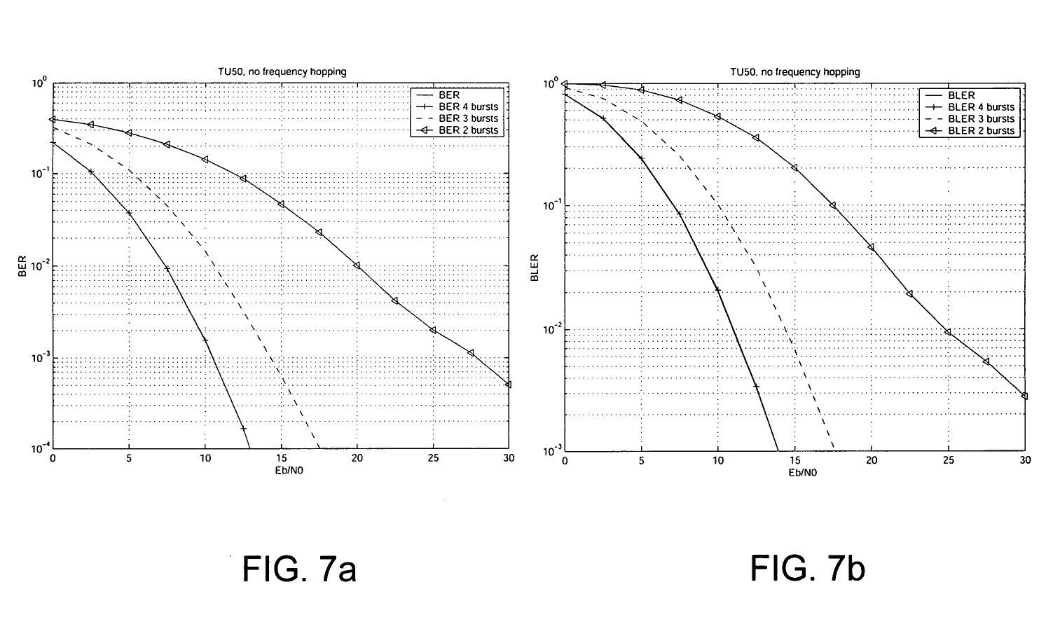

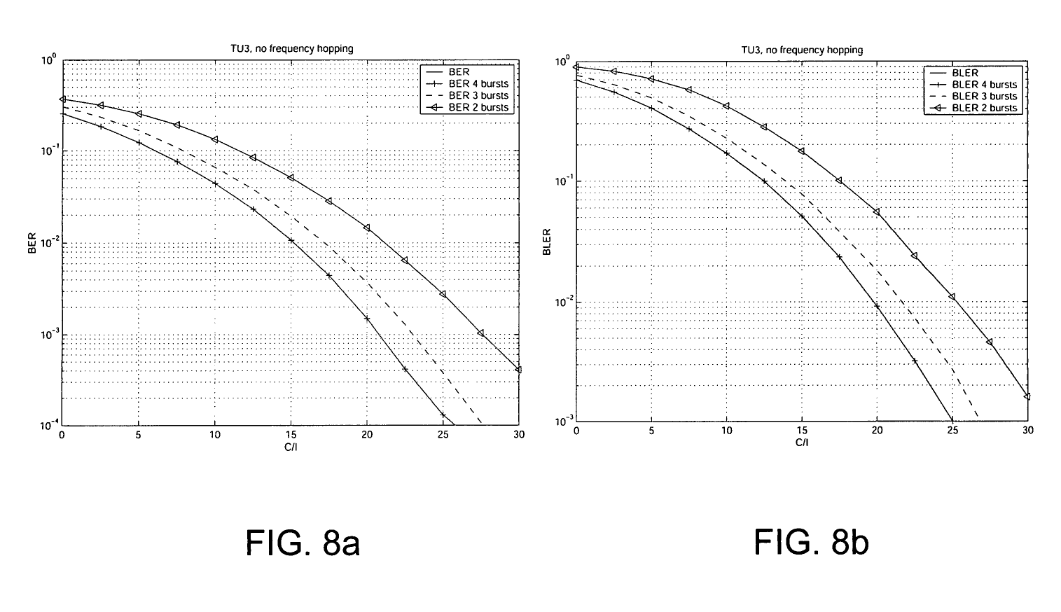

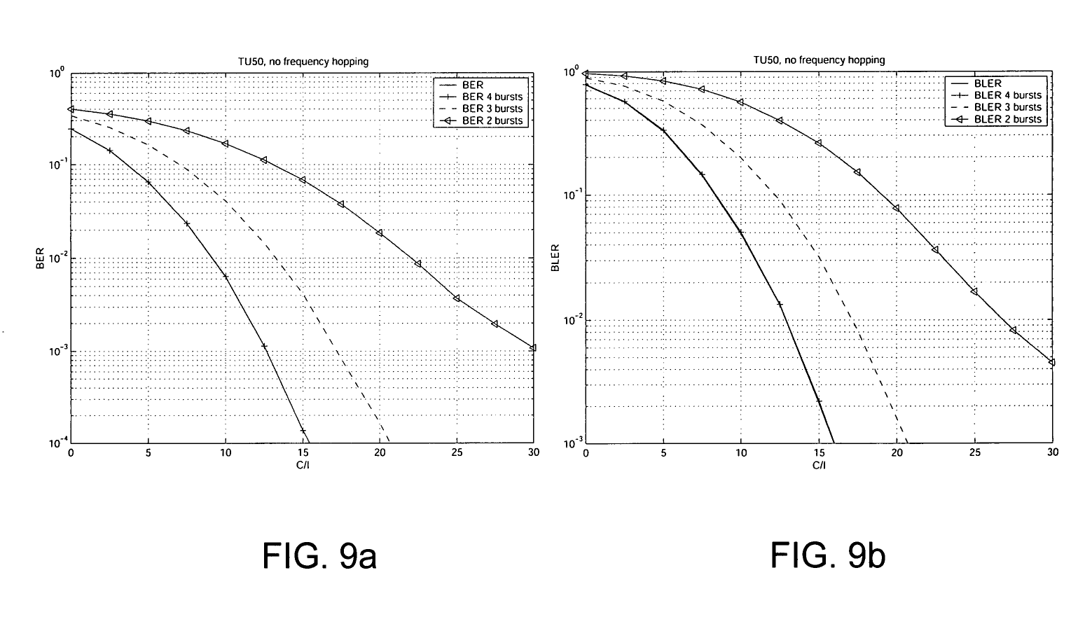

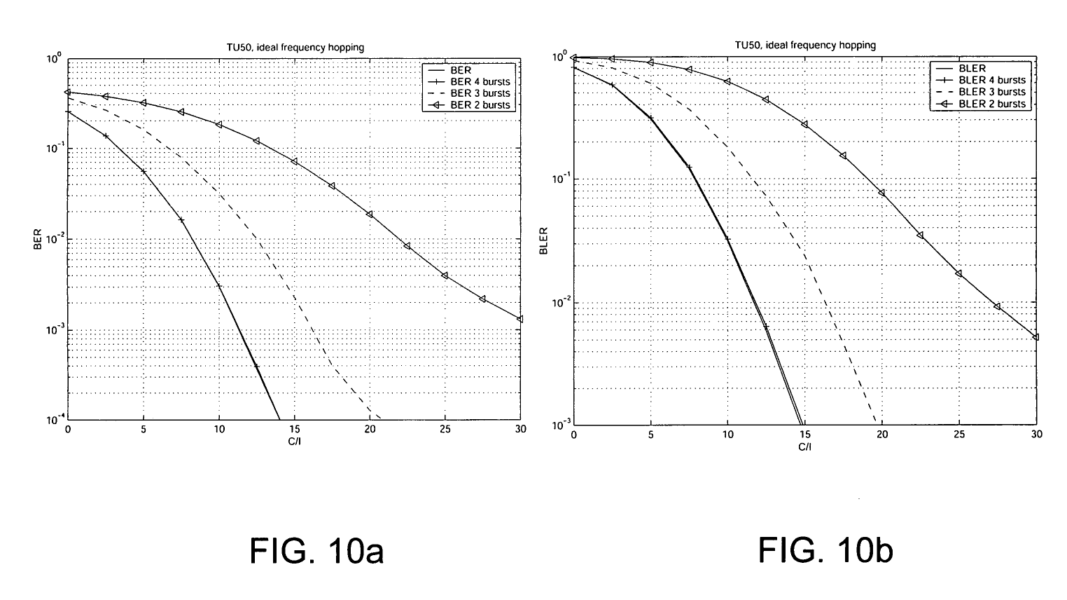

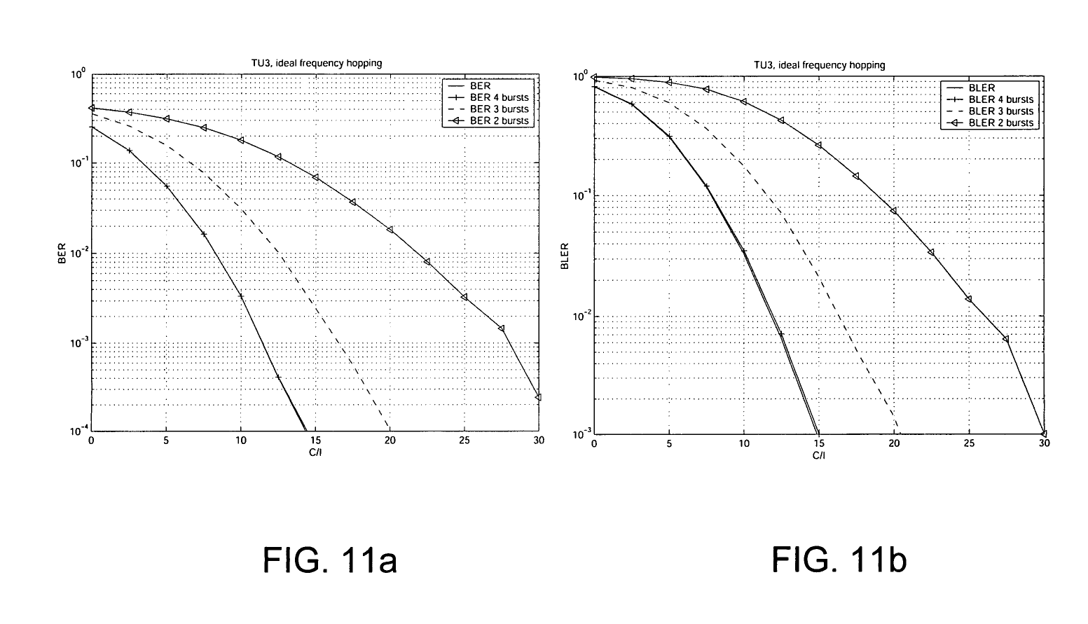

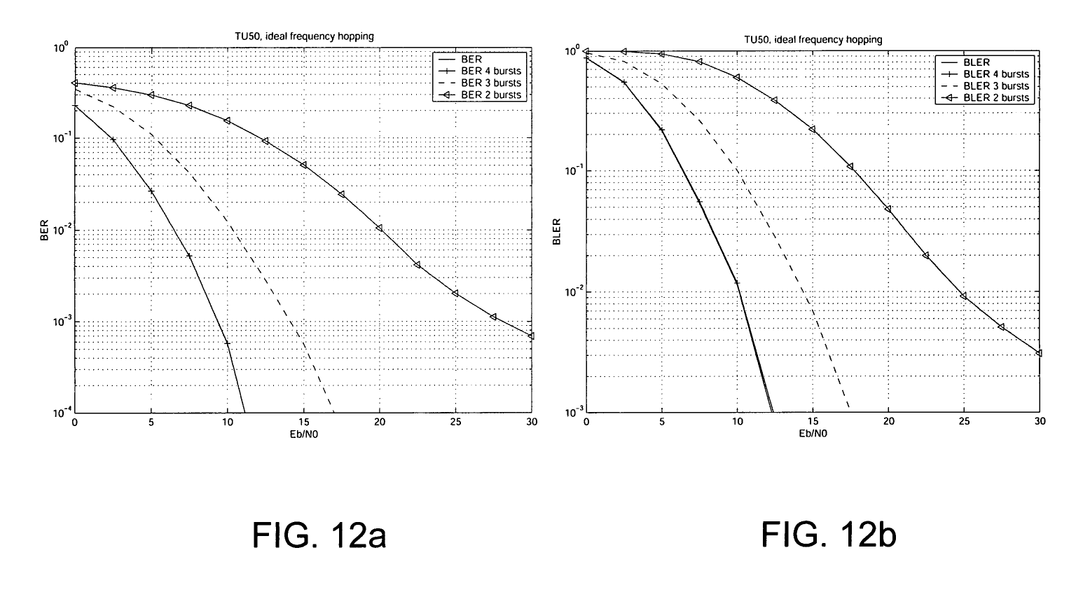

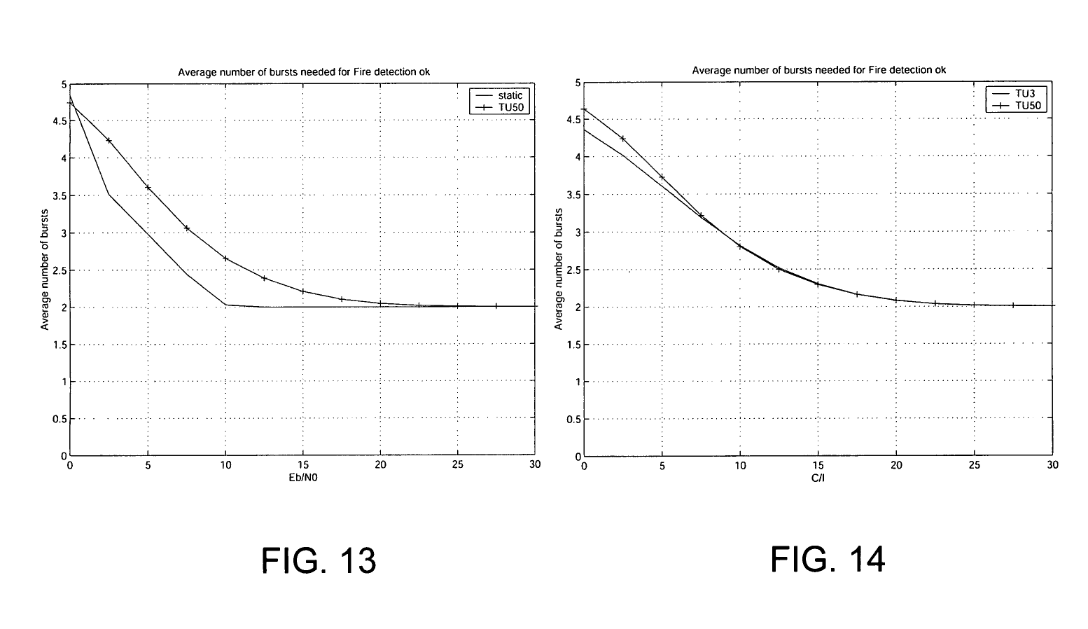

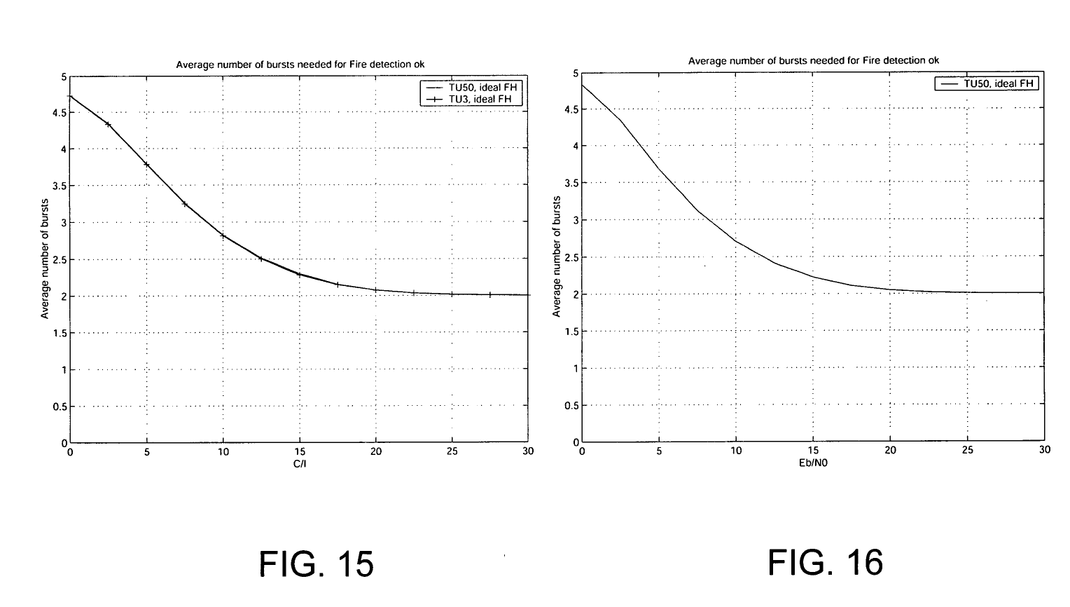

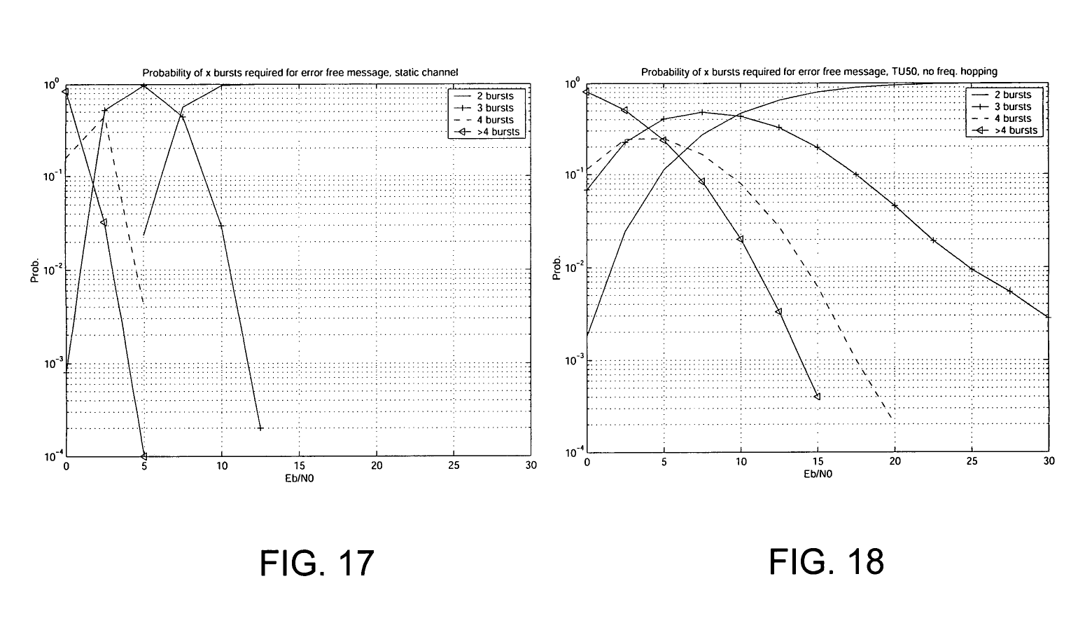

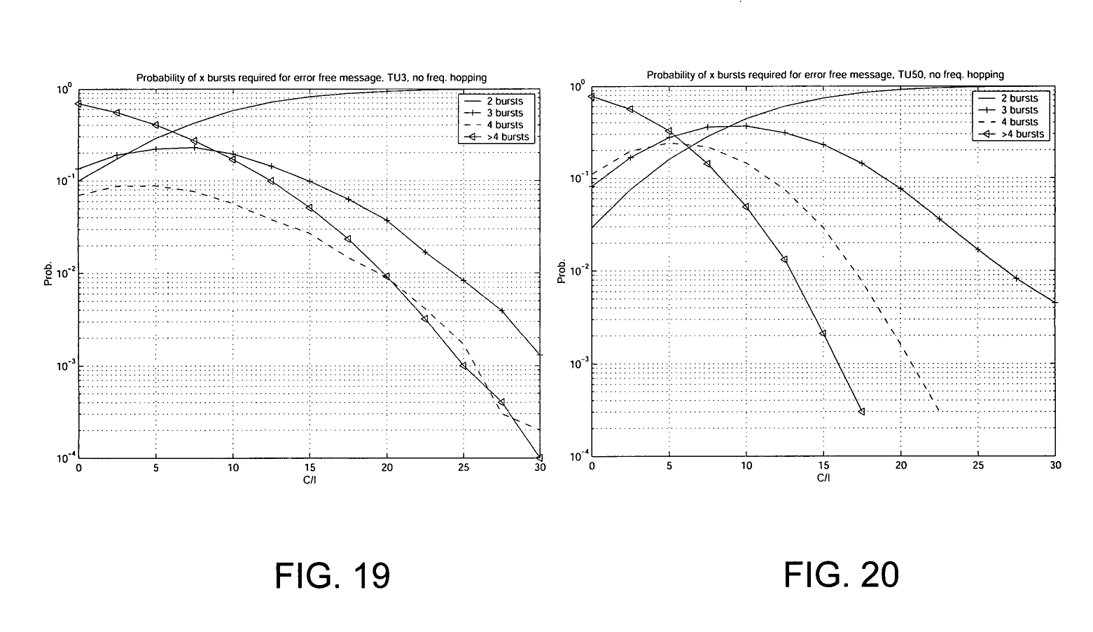

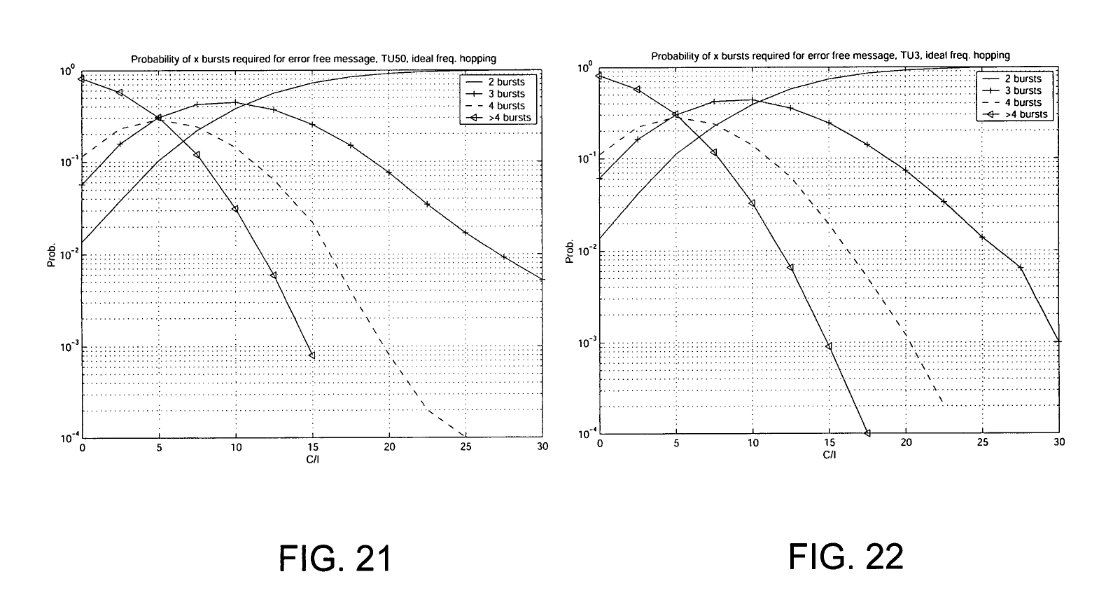

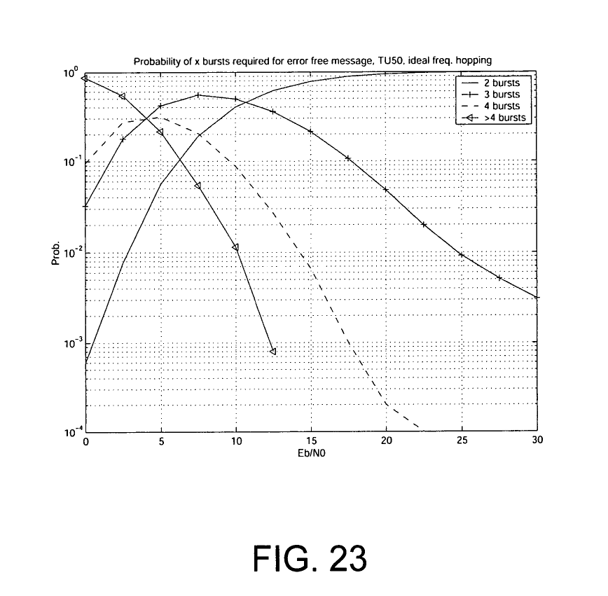

The test results are presented in FIGS. 6a through 23. Specifically:
FIG. 6a is a set of graphs depicting bit error rate (BER) plotted as a function of the signal-to-noise ratio (Eb/NO) for a static channel. The three graphs respectively correspond to the situations in which only 2 bursts are received, in which only 3 bursts are received, and in which all 4 bursts are received.
FIG. 6b is a set of graphs depicting block error rate (BLER) plotted as a function of the signal-to-noise ratio (Eb/NO) for a static channel. The three graphs respectively correspond to the situations in which only 2 bursts are received, in which only 3 bursts are received, and in which all 4 bursts are received.
FIG. 7a is a set of graphs depicting bit error rate (BER) plotted as a function of the signal-to-noise ratio (Eb/NO) for a TU50 channel without frequency hopping. The three graphs respectively correspond to the situations in which only 2 bursts are received, in which only 3 bursts are received, and in which all 4 bursts are received.
FIG. 7b is a set of graphs depicting block error rate (BLER) plotted as a function of the signal-to-noise ratio (Eb/NO) for a TU50 channel without frequency hopping. The three graphs respectively correspond to the situations in which only 2 bursts are received, in which only 3 bursts are received, and in which all 4 bursts are received.
FIG. 8a is a set of graphs depicting bit error rate (BER) plotted as a function of the signal-to-noise ratio (C/I) for a TU3 channel without frequency hopping. The three graphs respectively correspond to the situations in which only 2 bursts are received, in which only 3 bursts are received, and in which all 4 bursts are received.
FIG. 8b is a set of graphs depicting block error rate (BLER) plotted as a function of the signal-to-noise ratio (C/I) for a TU3 channel without frequency hopping. The three graphs respectively correspond to the situations in which only 2 bursts are received, in which only 3 bursts are received, and in which all 4 bursts are received.
FIG. 9a is a set of graphs depicting bit error rate (BER) plotted as a function of the signal-to-noise ratio (C/I) for a TU50 channel without frequency hopping. The three graphs respectively correspond to the situations in which only 2 bursts are received, in which only 3 bursts are received, and in which all 4 bursts are received.
FIG. 9b is a set of graphs depicting block error rate (BLER) plotted as a function of the signal-to-noise ratio (C/I) for a TU50 channel without frequency hopping. The three graphs respectively correspond to the situations in which only 2 bursts are received, in which only 3 bursts are received, and in which all 4 bursts are received.
FIG. 10a is a set of graphs depicting bit error rate (BER) plotted as a function of the signal-to-noise ratio (C/I) for a TU50 channel with ideal frequency hopping. The three graphs respectively correspond to the situations in which only 2 bursts are received, in which only 3 bursts are received, and in which all 4 bursts are received.
FIG. 10b is a set of graphs depicting block error rate (BLER) plotted as a function of the signal-to-noise ratio (C/I) for a TU50 channel with ideal frequency hopping. The three graphs respectively correspond to the situations in which only 2 bursts are received, in which only 3 bursts are received, and in which all 4 bursts are received.
FIG. 11a is a set of graphs depicting bit error rate (BER) plotted as a function of the signal-to-noise ratio (C/I) for a TU3 channel with ideal frequency hopping. The three graphs respectively correspond to the situations in which only 2 bursts are received, in which only 3 bursts are received, and in which all 4 bursts are received.
FIG. 11b is a set of graphs depicting block error rate (BLER) plotted as a function of the signal-to-noise ratio (C/I) for a TU3 channel with ideal frequency hopping. The three graphs respectively correspond to the situations in which only 2 bursts are received, in which only 3 bursts are received, and in which all 4 bursts are received.
FIG. 12a is a set of graphs depicting bit error rate (BER) plotted as a function of the signal-to-noise ratio (Eb/NO) for a TU50 channel with ideal frequency hopping. The three graphs respectively correspond to the situations in which only 2 bursts are received, in which only 3 bursts are received, and in which all 4 bursts are received.
FIG. 12b is a set of graphs depicting block error rate (BLER) plotted as a function of the signal-to-noise ratio (Eb/NO) for a TU50 channel with ideal frequency hopping. The three graphs respectively correspond to the situations in which only 2 bursts are received, in which only 3 bursts are received, and in which all 4 bursts are received.
FIG. 13 is a set of graphs depicting the average number of bursts needed for a fire decoder to declare an error free block plotted as a function of the signal-to-noise ratio (Eb/NO). Two curves are shown: one for a static channel, and another for a TU50 channel without frequency hopping.
FIG. 14 is a set of graphs depicting the average number of bursts needed for a fire decoder to declare an error free block plotted as a function of the carrier-to-interference (C/I). Two curves are shown: one for a TU3 channel without frequency hopping; and another for a TU50 channel without frequency hopping.
FIG. 15 is a set of graphs depicting the average number of bursts needed for a fire decoder to declare an error free block plotted as a function of the carrier-to-interference ratio (C/I). Two curves are shown: one for a TU50 channel with ideal frequency hopping; and another for a TU3 channel with ideal frequency hopping.
FIG. 16 is a set of graphs depicting the average number of bursts needed for a fire decoder to declare an error free block plotted as a function of the signal-to-noise ratio (Eb/NO). The curve shown is for a TU50 channel with ideal frequency hopping.
FIG. 17 is a set of graphs depicting the probability of x bursts being required to decode an error free message as a function of signal-to-noise ratio (Eb/NO) on a static channel. Four curves are presented: one for x=2 bursts; one for x=3 bursts; one for x=4 bursts; and one for x>4 bursts (meaning that there is still an error in the received message despite having received all four bursts).
FIG. 18 is a set of graphs depicting the probability of x bursts being required to decode an error free message as a function of signal-to-noise ratio (Eb/NO) on a TU50 channel without frequency hopping. Four curves are presented: one for x=2 bursts; one for x=3 bursts; one for x=4 bursts; and one for x>4 bursts (meaning that there is still an error in the received message despite having received all four bursts).
FIG. 19 is a set of graphs depicting the probability of x bursts being required to decode an error free message as a function of carrier-to-interference ratio (C/I) on a TU3 channel without frequency hopping. Four curves are presented: one for x=2 bursts; one for x=3 bursts; one for x=4 bursts; and one for x>4 bursts (meaning that there is still an error in the received message despite having received all four bursts).
FIG. 20 is a set of graphs depicting the probability of x bursts being required to decode an error free message as a function of carrier-to-interference ratio (C/I) on a TU50 channel without frequency hopping. Four curves are presented: one for x=2 bursts; one for x=3 bursts; one for x=4 bursts; and one for x>4 bursts (meaning that there is still an error in the received message despite having received all four bursts).
FIG. 21 is a set of graphs depicting the probability of x bursts being required to decode an error free message as a function of carrier-to-interference ratio (C/I) on a TU50 channel with ideal frequency hopping. Four curves are presented: one for x=2 bursts; one for x=3 bursts; one for x=4 bursts; and one for x>4 bursts (meaning that there is still an error in the received message despite having received all four bursts).
FIG. 22 is a set of graphs depicting the probability of x bursts being required to decode an error free message as a function of carriers-to-interference ratio (C/I) on a TU3 channel with ideal frequency hopping. Four curves are presented: one for x=2 bursts; one for x=3 bursts; one for x=4 bursts; and one for x>4 bursts (meaning that there is still an error in the received message despite having received all four bursts).
FIG. 23 is a set of graphs depicting the probability of x bursts being required to decode an error free message as a function of signal-to-noise ratio (Eb/NO) on a TU50 channel with ideal frequency hopping. Four curves are presented: one for x=2 bursts; one for x=3 bursts; one for x=4 bursts; and one for x>4 bursts (meaning that there is still an error in the received message despite having received all four bursts).

It can be seen from FIGS. 13, 14, 15, and 16 that the average number of bursts needed to get an error free message is 2 bursts for high signal-to-noise ratios and less than 2.5 bursts for signal-to-noise ratios over 10 dB, which is in the typical operating range.

From FIGS. 17, 18, 19, 20, 21, 22, and 23 it can be seen that the probability of two bursts being sufficient for error-free reception reaches 90% for C/I>15 dB. This means that for C/I>15 dB, two bursts is enough for an error free message in 90% of the cases.

On average, performance will be satisfactory when receiving, on average, fewer than 2.5 of the 4 bursts that make up the whole PCH/BCCH message. If for example a PCH/BCCH message can be decoded after 2 bursts, the receiver only has to be switched on for half the time required to receive all 4 bursts. For most cases and at good channel conditions, decoding after 2 bursts gives an error free message and no extra decoding has to be performed with this new approach.

Practical embodiments of the various aspects of the invention should take into account a requirement that there be sufficient time between bursts for decoding of the PCH/BCCH message, to determine whether the decoded bits are error-free, and to determine which further actions to take based on whether the decoded bits are error-free or not.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of receiving a message that comprises encoded bits interleaved over N transmission bursts, wherein N is greater than 1, the method comprising:
receiving a first transmission burst;
receiving a second transmission burst;
decoding the first and second transmission bursts to generate first decoded data;
determining whether the first decoded data is error free; and
inhibiting reception of remaining transmission bursts of the message if the first decoded data is error free, otherwise receiving a third transmission burst.

2. The method of claim 1, wherein the method is performed by a mobile terminal while in idle mode.

3. The method of claim 1, wherein the message is a Broadcast Control Channel message.

4. The method of claim 1, wherein the message is a Paging Channel message.

5. The method of claim 1, wherein the message is a Packet Paging Channel message.

6. The method of claim 1, wherein the message is a Packet Broadcast Control Channel message.

7. The method of claim 1, wherein N=4

8. The method of claim 1, wherein determining whether the first decoded data is error free comprises calculating a cyclic redundancy code (CRC) from the first decoded data, and comparing the calculated CRC to a CRC that is included within the first decoded data.

9. The method of claim 8, wherein calculating the CRC from the first decoded data comprises calculating a fire code from the first decoded data.

10. A method of receiving a message that comprises encoded bits interleaved over N transmission bursts, wherein N is greater than 1, the method comprising:
receiving fewer than N of the transmission bursts, whereby there exist remaining ones of the N transmission bursts that have not been received;
decoding all of the received transmission bursts to generate decoded data;
determining whether the decoded data is error free;
inhibiting reception of remaining transmission bursts of the message if the decoded data is error free, otherwise receiving one or more remaining ones of the N transmission bursts.

11. The method of claim 10, wherein receiving one or more remaining ones of the N transmission bursts comprises:
a) receiving one of the remaining ones of the N transmission bursts;
b) producing a combination of transmission bursts by combining the received one of the remaining ones of the N transmission bursts with all previously received ones of the N transmission bursts;
c) decoding the combination of transmission bursts to generate new decoded data;
d) determining whether the new decoded data is error free; and
e) inhibiting reception of remaining transmission bursts of the message if the new decoded data is error free, otherwise repeating a) through e) until all N transmission bursts have been received.

12. The method of claim 10, wherein the method is performed by a mobile terminal while in idle mode.

13. The method of claim 10, wherein the message is a Broadcast Control Channel message.

14. The method of claim 10, wherein the message is a Paging Channel message.

15. The method of claim 10, wherein the message is a Packet Paging Channel message.

16. The method of claim 10, wherein the message is a Packet Broadcast Control Channel message.

17. The method of claim 10, wherein N=4

18. The method of claim 10, wherein:
determining whether the decoded data is error free comprises calculating a cyclic redundancy code (CRC) from the decoded data, and comparing the calculated CRC to a CRC that is included within the decoded data; and
determining whether the new decoded data is error free comprises calculating a new CRC from the new decoded data, and comparing the calculated new CRC to a CRC that is included within the new decoded data.

19. The method of claim 18, wherein:
calculating the CRC from the decoded data comprises calculating a fire code from the decoded data; and
calculating the new CRC from the new decoded data comprises calculating a fire code from the new decoded data.

20. An apparatus for receiving a message that comprises encoded bits interleaved over N transmission bursts, wherein N is greater than 1, the apparatus comprising:
logic that receives a first transmission burst;
logic that receives a second transmission burst;
logic that decodes the first and second transmission bursts to generate first decoded data;
logic that determines whether the first decoded data is error free; and
logic that inhibits reception of remaining transmission bursts of the message if the first decoded data is error free, and otherwise receives a third transmission burst.

21. The apparatus of claim 20, wherein:
the apparatus is included in a mobile terminal; and
the logic that receives the first transmission burst, the logic that receives the second transmission burst, the logic that decodes the first and second transmission bursts, the logic that determines whether the first decoded data is error free, and the logic that inhibits reception of remaining transmission burst of the message if the first decoded data is error free are adapted to be active during an idle mode of the mobile terminal.

22. The apparatus of claim 20, wherein the message is a Broadcast Control Channel message.

23. The apparatus of claim 20, wherein the message is a Paging Channel message.

24. The apparatus of claim 20, wherein the message is a Packet Paging Channel message.

25. The apparatus of claim 20, wherein the message is a Packet Broadcast Control Channel message.

26. The apparatus of claim 20, wherein N=4

27. The apparatus of claim 20, wherein the logic that determines whether the first decoded data is error free comprises logic that calculates a cyclic redundancy code (CRC) from the first decoded data, and compares the calculated CRC to a CRC that is included within the first decoded data.

28. The apparatus of claim 27, wherein the logic that calculates the CRC from the first decoded data comprises logic that calculates a fire code from the first decoded data.

29. An apparatus for receiving a message that comprises encoded bits interleaved over N transmission bursts, wherein N is greater than 1, the apparatus comprising:
logic that receives fewer than N of the transmission bursts, whereby there exist remaining ones of the N transmission bursts that have not been received;
logic that decodes all of the received transmission bursts to generate decoded data;
logic that determines whether the decoded data is error free;
logic that inhibits reception of remaining transmission bursts of the message if the decoded data is error free, otherwise receiving one or more remaining ones of the N transmission bursts.

30. The apparatus of claim 29, wherein the logic that receives one or more remaining ones of the N transmission bursts comprises:
a) logic that receives one of the remaining ones of the N transmission bursts;
b) logic that produces a combination of transmission bursts by combining the received one of the remaining ones of the N transmission bursts with all previously received ones of the N transmission bursts;
c) logic that decodes the combination of transmission bursts to generate new decoded data;
d) logic that determines whether the new decoded data is error free; and
e) logic that inhibits reception of remaining transmission bursts of the message if the new decoded data is error free, and otherwise causes logic a) through e) to repeat operation until all N transmission bursts have been received.

31. The apparatus of claim 29, wherein:
the apparatus is included in a mobile terminal; and
the apparatus is operated when the mobile terminal is in an idle mode.

32. The apparatus of claim 29, wherein the message is a Broadcast Control Channel message.

33. The apparatus of claim 29, wherein the message is a Paging Channel message.

34. The apparatus of claim 29, wherein the message is a Packet Paging Channel message.

35. The apparatus of claim 29, wherein the message is a Packet Broadcast Control Channel message.

36. The apparatus of claim 29, wherein N=4

37. The apparatus of claim 29, wherein:
the logic that determines Whether the decoded data is error free comprises logic that calculates a cyclic redundancy code (CRC) from the decoded data, and compares the calculated CRC to a CRC that is included within the decoded data; and
the logic that determines whether the new decoded data is error free comprises logic that calculates a new CRC from the new decoded data, and compares the calculated new CRC to a CRC that is included within the new decoded data.

38. The apparatus of claim 37, wherein:
the logic that calculates the CRC from the decoded data comprises logic that calculates a fire code from the decoded data; and
the logic that calculates the new CRC from the new decoded data comprises logic that calculates a fire code from the new decoded data.

39. A machine-readable storage medium having stored thereon a set of program instructions for causing a processor-controlled mobile terminal to receive a message that comprises encoded bits interleaved over N transmission bursts, wherein N is greater than 1, the set of program instructions causing the processor-controlled mobile terminal to perform:
receiving a first transmission burst;
receiving a second transmission burst;
decoding the first and second transmission bursts to generate first decoded data;
determining whether the first decoded data is error free; and
inhibiting reception of remaining transmission bursts of the message if the first decoded data is error free, otherwise receiving a third transmission burst.

40. A machine-readable storage medium having stored thereon a set of program instructions for causing a processor-controlled mobile terminal to receive a message that comprises encoded bits interleaved over N transmission bursts, wherein N is greater than 1, the set of program instructions causing the processor-controlled mobile terminal to perform:
receiving fewer than N of the transmission bursts, whereby there exist remaining ones of the N transmission bursts that have not been received;
decoding all of the received transmission bursts to generate decoded data;
determining whether the decoded data is error free;
inhibiting reception of remaining transmission bursts of the message if the decoded data is error free, otherwise receiving one or more remaining ones of the N transmission bursts.
